(19) United States
(12) Patent Application Publication
(10) Pub. No.: US 2006/0218016 A1
(43) Pub. Date: Sep. 28, 2006

(54) Method and system for archiving medical device compliance documents

(75) Inventors: Wilfried Hohn, Birkenweg (DE); Gerald Exenberger, Kiefernweg (DE)

Correspondence Address: BRINKS HOFER GILSON & LIONE, P.O. BOX 10395, CHICAGO, IL, 60610, US

(73) Assignee: SIEMENS AKTIENGESELLSCHAFT

(21) Appl. No.: 11/076,289

(22) Filed: Mar. 8, 2005

(51) Int. Cl. G06Q 40/00

(52) U.S. Cl. 705/4

(57) ABSTRACT

A method and system for archiving medical device compliance documents are provided. In one embodiment, a method and system are described for generating a plurality of compliance documents for a medical device, providing the plurality of compliance documents to a storage device accessible over a network, and storing the plurality of compliance documents in the storage device. Other embodiments are provided, and each of the embodiments described herein can be used alone or in combination with one another.

### BACKGROUND

Medical device users are required to retain certain documents to meet governmental rules, such as FDA regulations and the Medical Product Law in Germany, and have those documents readily accessible so that they can be presented for inspection to governmental authorities when requested. These documents typically come from different sources and can be in different forms. For example, regulations may require an operators handbook, a quality checklist, and various test certificates to be stored together near the medical device. Because these documents are issued at different times and come from different sources, a user may not always have these documents stored together. Compounding the problem is the fact that some of the documents may be stored in paper form while others are stored electronically.

### SUMMARY

The present invention is defined by the following claims, and nothing in this section should be taken as a limitation on those claims.

By way of introduction, the below embodiments describe a method and system for archiving medical device compliance documents. In one embodiment, a method and system are described for generating a plurality of compliance documents for a medical device, providing the plurality of compliance documents to a storage device accessible over a network, and storing the plurality of compliance documents in the storage device. Other embodiments are provided, and each of the embodiments described herein can be used alone or in combination with one another.

The embodiments will now be described with reference to the attached drawings.

### BRIEF DESCRIPTION OF THE DRAWINGS

FIG. 1 is a block diagram of a system of an embodiment.

FIG. 2 is a flowchart of a method of an embodiment.

### DETAILED DESCRIPTION OF THE PRESENTLY PREFERRED EMBODIMENTS

By way of introduction, the following embodiments relate to the storage of compliance documents for a medical device (or “medical device compliance documents”). A medical device compliance document refers to any document related to a medical device that is required by governmental rules, such as FDA regulations in the United States and the Medical Product Law in Germany, to be present near the medical device or otherwise easily accessible. A medical device compliance document can be a paper or electronic document and can evidence some maintenance, safety, consistency, or quality check procedure for the medical device or can be a document unrelated to such procedures but nonetheless required to be near the medical device or otherwise readily accessible (such as an operators handbook). Typically, a plurality of medical device compliance documents are associated with a given medical device.

One example of a medical device compliance document is a medical product book, which is a technical book that contains a regular maintenance or quality checklist to be completed several times a year by an original equipment manufacturer (OEM) or one of its partners to determine whether a medical device is still in-line with its specifications. The types of outputs tested and documented in the medical product book include, but are not limited to, voltage, amps, power, sharpness of image edges, number of displayed lines per inch, and point of image rotation. Another example of a medical device compliance document is a test certificate, which certifies whether the medical device contains any electrical or mechanical deficiency and whether required documents and labels are present. Also, as mentioned above, a medical device compliance document can be a document that is unrelated to test procedures, such as an operators handbook.

As discussed in the background section above, medical device compliance documents for a medical device are typically stored in paper form near the medical device. Because these documents are issued at different times and come from different sources, a user may find it difficult to maintain a complete collection of all the medical device compliance documents. The embodiments presented herein provide for a common electronic depository for the medical device compliance documents.

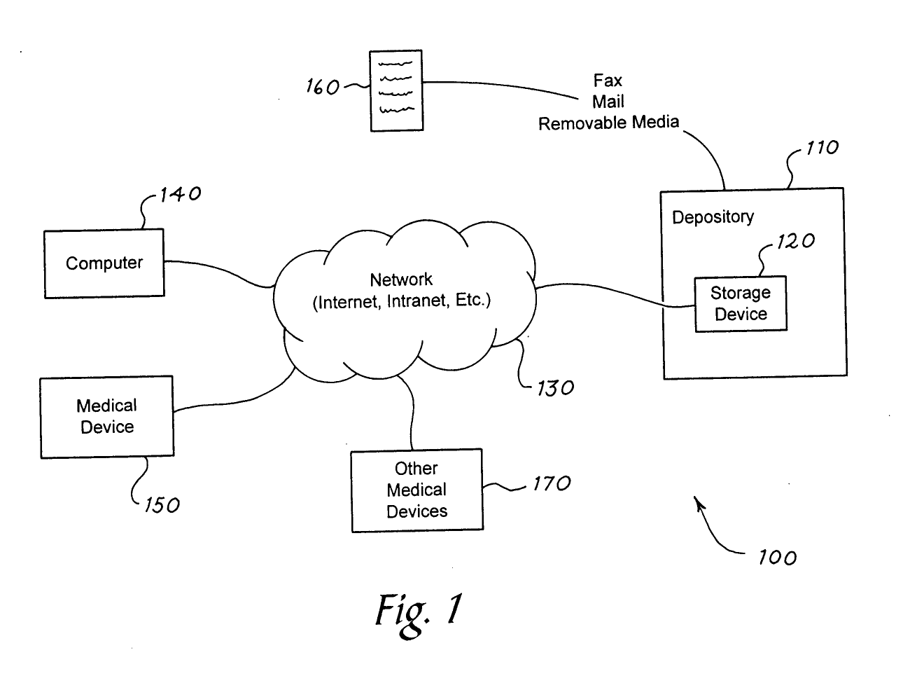

Turning now to the drawings, FIG. 1 is a block diagram of a system 100 of a preferred embodiment. This system comprises a depository 110 with a storage device 120 (the “medical product archive”) for electronically storing a plurality of medical device compliance documents (preferably, all of the required medical device compliance documents) for a given medical device. The storage device 120 is accessible via a network 130 (e.g., the Internet, an intranet, etc.) by a computer 140 or by the medical device 150 itself if it has the capability of connecting to the network 130. The depository 110 can be maintained by an entity associated with a manufacturer of the medical device (e.g., the OEM or a partner of the OEM) or a third party. Also, the term “computer” is used herein to broadly refer to any electronic device that can perform the functionality described herein. Examples of computers include, but are not limited to, general-purpose computers, personal digital assistants, and cell phones with the appropriate hardware and/or software.

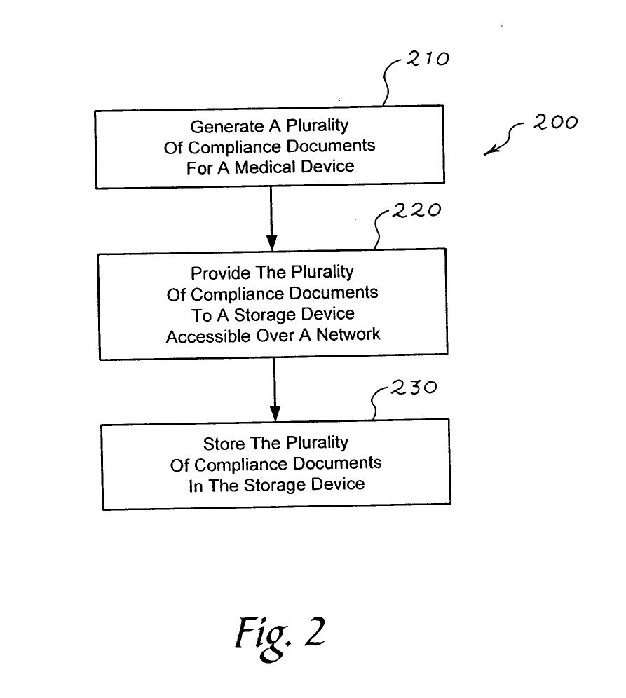

FIG. 2 is a flowchart 200 of a method for use with this system 100. First, a plurality of compliance documents for a medical device are generated (act 210). As described above, compliance documents can take the form of a medical product book, a test certificate, an operators handbook, or any other type of required document. The plurality of compliance documents do not have to be generated at the same time. For example, if regulations require a medical device to be tested multiple times during a year, the plurality of compliance documents can be generated throughout the year. Alternatively, the plurality of compliance documents can be generated in a single session.

Next, the plurality of compliance documents are provided to the storage device 120 (act 220), and the plurality of compliance documents are stored in the storage device 120 (act 230). The plurality of compliance documents can be provided to the storage device 120 in any suitable way. For example, generated paper compliance documents can be scanned in and sent from the computer 140 as a PDF file in an email, and electronically-generated compliance documents can be electronically sent without the need to first generate a hard copy. Additionally, a user can use the computer 140 to log-on to the depository's web page and create a compliance document on-line using a graphic user interface (in this situation, acts 210 and 220 would be performed in a single act). If it has the capability of connecting to the network 130, the medical device 150 can provide compliance documents in the same way as the computer 140. Additionally, the depository 110 may contain functionality to test the medical device 150 remotely and automatically create a compliance document (in this situation, acts 210 and 220 would be performed in a single act). Further, instead of being provided via the network 130, compliance documents can be sent to storage device 120 in other forms. For example, a user can fax or mail a hard copy of a compliance document 160 to the depository 110, or can send an electronic version of a compliance document to the depository 110 on removable media, such as a disk, CD, or memory card.

It should be noted that while FIG. 1 shows lines connecting the network 130 to various elements, transmissions can occur wirelessly instead of through a wired connection. Also, various compliance documents can be provided to the storage device 120 in different ways. For example, some compliance documents for a medical device can be sent from the computer 140, while other compliance documents for the medical device can be faxed to the depository 110.

By being stored in the storage device 120, one or more of the compliance documents can be retrieved via the network 130 at the computer 140, the medical device 140, or any other networked device. Because of the networked environment, the stored compliance documents can be accessed from anywhere within that network. Accordingly, if the network 130 is the Internet, the stored compliance documents can be accessed from anywhere in the world.

There are several advantages associated with these embodiments. First, storing the compliance documents for a medical device in a central location (the storage device 120 of the depository 110) ensures that the documents will almost always be available for inspection, unlike the current situation in which a user may not always have the documents stored together. Additionally, because the compliance documents are stored electronically in the storage device 120, the search for compliance documents is substantially faster and more convenient than searching paper copies. This allows a user to quickly produce all relevant documents when needed. Also, by storing the compliance documents electronically on the centralized storage device 120, existing electronic compliance documents can be transferred directly and automatically to the storage device 120 and no longer need to be converted first to paper.

Additionally, by having the compliance documents stored on a networked storage device 120, the user need not operate and maintain his own archive for the compliance documents. This provide a security advantage to the user. Having the compliance documents safely archived in a networked storage device 120 that is proven to be safe removes the risk that the documents can be destroyed in a disaster local to the medical device, such as a fire. Further, because there is only one security concept, the integrity of the compliance documents is less expensive and easier to maintain, thereby leading to higher compliance with government regulations.

There are several alternatives that can be used with these embodiments. For example, instead of storing compliance documents for just one medical device 150, the storage device 120 can store compliance documents for other medical devices 170. In this way, the depository 110 can be maintained by an OEM to store compliance documents for all of its manufactured medical devices. Additionally, the depository 110 can search the Internet for the most up-to-date compliance documents to be completed and provide those to the user, e.g., via a web site. Additionally, the depository 110 can be equipped with functionality to determine which compliance documents are required for a given medical device and provide a warning to the user if any required compliance documents are missing from the storage device 120. This provides an additional safety aspect in that an alarm is raised if a required compliance document is not regularly stored. In this way, the user has a watching function that keeps him up-to-date and always ready for quality and governmental check ups. To identify the medical device to the depository 110, the depository 110 can provide a web site for a user to manually enter identification information (e.g., by typing the serial number of the medical device into fields in a graphic user interface), or, if the medical device 150 is connected to the network 130, the depository 110 can automatically poll and identify the medical device 150.

The above-described functionality can be implemented using any appropriate hardware and/or software component. In one embodiment, the functionality is implemented on an article of manufacture comprising a computer-readable storage medium and computer-readable data stored therein. Examples of the article include, but are not limited to, an electronic storage medium having electronic data, a magnetic storage medium having magnetic data, and an optical storage medium having optical data.

Lastly, it should be noted that the term “medical device” is intended to broadly cover any medical device, including, but not limited to, medical imaging devices, such as ultrasound imaging systems and those that use any of the following imaging modalities: computed tomography (CT), magnetic resonance imaging (MRI), computed radiography, magnetic resonance, angioscopy, color flow Doppler, cystoscopy, diaphanography, echocardiography, fluoresosin angiography, laparoscopy, magnetic resonance angiography, positron emission tomography, single-photon emission computed tomography, x-ray angiography, computed tomography, nuclear medicine, biomagnetic imaging, culposcopy, duplex Doppler, digital microscopy, endoscopy, fundoscopy, laser surface scan, magnetic resonance spectroscopy, radiographic imaging, thermography, and radio fluroscopy.

It is intended that the foregoing detailed description be understood as an illustration of selected forms that the invention can take and not as a definition of the invention. It is only the following claims, including all equivalents, that are intended to define the scope of this invention.

What is claimed is:

1. A method for storing medical device compliance documents, the method comprising:
(a) generating a plurality of compliance documents for a medical device;
(b) providing the plurality of compliance documents to a storage device accessible over a network; and
(c) storing the plurality of compliance documents in the storage device.

2. The method of claim 1 further comprising:
(d) retrieving at least one of the plurality of compliance documents from the storage device.

3. The method of claim 1, wherein the storage device stores all compliance documents for the medical device.

4. The method of claim 1, wherein the network comprises the Internet.

5. The method of claim 1, wherein the network comprises an intranet.

6. The method of claim 1, wherein (a) comprises generating at least one compliance document using a graphic user interface.

7. The method of claim 1, wherein (b) comprises sending at least one of the compliance documents to the storage device from a computer in communication with the storage device via the network.

8. The method of claim 1, wherein the medical device is in communication with the storage device via the network, and wherein (b) comprises sending at least one of the compliance documents to the storage device from the medical device.

9. The method of claim 1, wherein (b) comprises sending a hard copy of at least one of the compliance documents to an entity that will store the at least one of the compliance documents electronically in the storage device.

10. The method of claim 1, wherein (b) comprises sending removable media storing at least one of the compliance documents to an entity that will store the at least one of the compliance documents in the storage device.

11. The method of claim 1, wherein (b) comprises wirelessly transmitting at least one of the compliance documents to the storage device.

12. The method of claim 1, wherein at least one of the plurality of compliance documents comprises an operators handbook.

13. The method of claim 1, wherein at least one of the plurality of compliance documents comprises a test certificate.

14. The method of claim 1, wherein at least one of the plurality of compliance documents comprises a medical product book.

15. The method of claim 1, wherein the storage device is maintained by an entity associated with a manufacturer of the medical device.

16. The method of claim 1, wherein the storage device stores a plurality of compliance documents for each of a respective plurality of medical devices.

17. The method of claim 1 further comprising:
providing, via the network, a user of the medical device with an up-to-date compliance document.

18. The method of claim 1 further comprising:
providing an identification of the medical device; and
providing a warning if the storage device is missing a compliance document required for the identified medical device.

19. The method of claim 18, wherein the identification is automatically provided.

20. The method of claim 18, wherein the identification is manually provided.
